(19) United States
(12) Patent Application Publication
(10) Pub. No.: US 2017/0028533 A1
(43) Pub. Date: Feb. 2, 2017

(54) ADJUSTABLE PLIERS

(71) Applicant: STANLEY MIDDLE EAST FZE, Jebel Ali (UA)

(72) Inventor: Aude KAULEK, Pelousey (FR)

(21) Appl. No.: 15/217,641

(22) Filed: Jul. 22, 2016

(30) Foreign Application Priority Data
Jul. 24, 2015 (GB) 1513080.0

(51) Int. Cl. B25B 7/10

(52) U.S. Cl. CPC B25B 7/10

(57) ABSTRACT

Adjustable pliers for gripping and/or stabilizing nuts, bolts, pipes, rods, dowels, etc. The adjustable pliers includes a pivot member may, in order to adjust the opening of the pliers' jaws, slide within a notched elongated slot though one arm of the pliers. The slot connects a series of notches, or apertures, along its axis of elongation. The pivot member is keyed to the other arm of the pliers. The arms are pivotable to cause either engagement of the locking faces with one of the apertures to determine the opening of the jaws or disengagement of the locking faces to allow movement of the pivot member along the slot to vary the opening of the jaws. An operator may choose to locate the pivot member in one of the notches by sliding it with the arm to which it is keyed along the slot.

This patent application claims priority to GB application No. 1513080.0 filed 24 Jul. 2015 which is hereby incorporated by reference in its entirety.

I. Field of the Invention

The present invention relates generally to hand tools, and more particularly to an adjustable pliers in which a pivot member may slide within a notched elongated slot though one arm of the pliers.

II. Background of the Invention

Adjustable pliers are regarded as one of the most useful all-around gripping tool to have in a toolbox. They are regarded as a type of slip-joint pliers and generally have serrated jaws. The lower jaw can be moved to a number of positions by sliding along a tracking section under the upper jaw to adjust to a number of sizes without the distance in the handle growing wider. The jaws of the tool, regardless of the setting, remain parallel to one another, making them perfect for grabbing nuts, bolts, or any suitable material.

Patent publication FR976031 discloses adjustable pliers comprising an arm pivotably and adjustably connected to an arm by a pivot member. The arms comprise jaws at one end and handles at the other end. The pivot member is keyed to, and moves with, one of the arms. The other arm comprises an elongated slot with notches interposed by teeth on one side and a flat face on the other side of the slot.

The pivot member has, in cross-section, a pair of opposing parallel flat sides each separated by convex curved locking faces. The distance between the flat sides is inferior to the narrowest parts of the slot. The locking faces are sized to be located in the notches. The pivot member's cross-section is symmetrical about both its axis of elongation (parallel to the flat sides) and a plane orthogonal to its axis of elongation.

The jaws are cooperating, opposed clamping jaws. The jaws' opening may be adjusted and selected as follows. When the handles are turned to open the jaws to their maximum open position, the flat sides of the pivot member may slide along the slot. Upon arrival at a chosen notch, the handles may be turned to close the jaws. The pivot member turns with the arm to which it is keyed to cause engagement between the pivot member's locking faces and sides of the adjacent notch. The jaws are ready to grip an object.

Patent publication FR976031 identifies certain drawbacks with these adjustable pliers. The pivot member is generally obscured by the pliers' arms and adjustment of the pliers' jaws is largely a process of trial and error. For example, if the pivot member is turned prior to, or shortly after, correct location with respect to a notch, then collision between the notch's teeth and corners of the pivot member may occur. The operator must slide the pivot member along the slot and reattempt correct location until ultimately successful. This may involve several attempts and it will be frustrating for the operator. Over time it may result in premature wear to parts of the pivot member and sides of the slot.

Patent publication FR976031 addresses some of these drawbacks by providing a pivot member which resembles, in cross-section, a crescent with a concave side flanked by a pair of horns in what is otherwise a cylindrical pivot pin. With the pliers' jaws in the maximum open position, the two horns may pass under the line of teeth along one side of the slot while the cylindrical side slides against the flat opposite side of the slot. Adjustment of the pliers' jaws remains trial and error, yet once near an appropriate notch the pivot member may be turned to close the pliers' jaws while the concave side rocks its way under the nearest tooth. This encourages engagement between the pivot member and the notch. Nevertheless, the horns are still prone to clashing with the teeth when the pliers' jaws are in anything other than maximum open position.

Patent publication FR2584642 discloses adjustable pliers with similar construction to the adjustable pliers disclosed by FR976031. The articulation axis has a crescent-shaped cross-section. However, the elongated slot has notches interposed by teeth on both sides of the elongated slot. The curved shapes of the notches have been optimized to deliver improved locking characteristics. Otherwise, it works in a similar manner to the pliers is disclosed by FR976031 and has similar drawbacks.

Notwithstanding the usefulness of the above-described apparatuses, a need still exists for uncomplicated, easily utilized adjustable pliers.

### SUMMARY OF THE INVENTION

In various embodiments the patent disclosure provides an adjustable plier comprising a first arm and a second arm crossing each other intermediate of their ends, wherein each arm has a respective clamping jaw at one end and a respective handle at an opposite end thereof, wherein the first arm has intermediate of its ends and at the crossing by the second arm a plurality of spaced apart apertures through the first arm the apertures being connected by an elongated slot through the first arm, the slot being of lesser width than the apertures, wherein the second arm has a pivot member passing through the elongated slot to pivotally connect the arms to each other, wherein the pivot member has a profiled section receivable within any one of the apertures, wherein the profiled section comprises opposing convex curved locking faces each with a common axis of curvature and a first radius defining a notional outer circular perimeter of the profiled section, wherein the profiled section comprises a plurality of substantially opposing free faces separating the locking faces each free face being inset from the notional outer circular perimeter, wherein the other arm is pivotable in respect of the one arm in a rotational direction about the axis to cause engagement of the locking faces with a side of the first arm defining one of the apertures to determine the opening of the jaws with respect to each other and the second arm is pivotable in respect of the one arm in a counter rotational direction about the axis to cause disengagement of the locking faces from sides of the apertures to allow movement of the pivot member along the slot to vary the opening of the jaws with respect to each other, further comprising: at least one free face including a convex curved free face flanking one locking face in the rotational direction and having a second radius that is less than the first radius of the locking faces wherein the at least one second free face comprises a convex curved free face flanking the other locking face in the rotational direction and having a third radius, wherein the third radius is less than the second radius.

According to alternate embodiments of the present invention, an adjustable plier is provided wherein the profiled section has a generally curved trapezoidal shape in cross-section tapering towards the locking face flanked by the convex curved free face having the third radius,

According to alternate embodiments of the present invention, an adjustable plier is provided, wherein the profiled section is elongated between the opposing locking faces and has an axis of elongation which separates the plurality of free faces.

According to alternate embodiments of the present invention, an adjustable plier is provided, wherein a majority of the locking faces lies on an opposite side of the axis of elongation to the jaws.

According to alternate embodiments of the present invention, an adjustable plier is provided, wherein the convex curved free face having the third radius lies on an opposite side of the axis of elongation to the majority of the locking faces.

According to alternate embodiments of the present invention, an adjustable plier is provided, wherein the free faces are substantially convex.

According to alternate embodiments of the present invention, an adjustable plier is provided, wherein each face of the plurality of free faces comprises a flat free face parallel to the axis of elongation.

According to alternate embodiments of the present invention, an adjustable plier is provided, wherein each flat free face merges tangentially with convex curved free faces of its respective free face

According to alternate embodiments of the present invention, an adjustable plier is provided, wherein each free face comprises a convex curved free face flanking a respective locking face in the counter rotational direction and having the second radius.

In various other embodiments, the patent disclosure provides an adjustable plier comprising a pair of arms crossing each other intermediate of their ends, wherein each arm has a respective clamping jaw at one end and a respective handle at an opposite end thereof, wherein one arm has intermediate of its ends and at the crossing by the other arm a plurality of spaced apart apertures traversing the one arm, and the apertures being connected by an elongated slot of lesser width than the apertures, wherein the other arm has a pivot member passing through the slot to pivotally connect the arms to each other, wherein the pivot member has a profiled section receivable within any one of the apertures, and wherein the pivot member is configured to move along the slot to vary the opening of the jaws.

The profiled section of the adjustable pliers according to the present invention is a hybrid of locking faces for fixing the opening of the jaws with respect to each other and free faces which are spaced more closely to each other than the locking faces to allow movement of the profiled section along the elongated slot. The locking faces have a convex curved shape in cross-section. This provides tactile feedback to the operator as to when the pivot member is ready to engage sides of an aperture. When the other arm is pivoted in the counter rotational direction, such as counter clockwise for example, to cause disengagement of the locking faces from sides of an aperture, the free faces, which are inset from the notional outer circular perimeter, pivot towards the sides of the slot. The convex curved free faces initially approach the sides of the slot. The absence of corners on the profiled section helps smooth rotation of the pivot member in the aperture and helps guide passage of the profiled section along slot without the collision points of the prior art adjustable pliers. This helps to reduce component wear. The profiled section narrows towards one of the locking faces by way of the diminished third radius of one convex curved free face. Advantageously, the asymmetric narrowing of the profiled section provides a leading end which encourages smoother selection and direction of the profiled section within slot.

Preferably, the profiled section has a generally curved trapezoidal shape in cross-section tapering towards the locking face flanked by the convex curved free face having the third radius but is not limited in this regard and can be any suitable shape. This provides asymmetric narrowing of the profiled section around one of the locking faces.

Preferably, the profiled section is elongated between the opposing locking faces and has an axis of elongation which separates the free faces but is not limited in this regard and can be any suitable shape. Elongation of the profiled section encourages smooth movement of the profiled section along the elongated slot and enhances support of pivot member when the opening of the jaws is fixed.

Preferably, a majority of the locking faces lies on an opposite side of the axis of elongation to the jaws but are not limited in this regard and the number of locking faces can be any number. This can enhance support provided by the locking faces to the pivot member in reaction to forces produced by the jaws when gripping an object.

Preferably, the convex curved free face having the third radius lies on an opposite side of the axis of elongation to the majority of the locking faces. With this arrangement, the corner of the profiled section that initially slides from the aperture is the convex curved free face having the third radius. This can discourage collision between the profiled section and sides of the arm defining the apertures.

Preferably, the free faces are substantially convex but are not limited in this regard and can be any shape or form. This can helps smooth rotation and passage of the pivot member in the slot.

Preferably, each of the free faces comprises a flat free face parallel to the axis of elongation but is not limited in this regard and can the faces can include any shape, form, indentation, or protrusion. The flat free faces extend the profiled section in the direction of the axis of elongation.

Preferably, each flat free face merges tangentially with convex curved free faces of its respective free face. A tangential join between flat and curved free faces helps to avoid sharp corners.

Preferably, each free face comprises a convex curved free face flanking a respective locking face in the counter rotational direction and having the second radius. The helps smooth rotation and passage of the pivot member in the elongated slot whilst preserving asymmetric narrowing of the profiled section.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the root terms “include” and/or “have”, when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

For definitional purposes and as used herein “connected” or “attached” includes physical, whether direct or indirect, affixed or adjustably mounted, as for example, the second arm is keyed or operately connected to a pivot pin having a central axis of rotation. Thus, unless specified, “connected” or “attached” is intended to embrace any operationally functional connection.

As used herein “substantially,” “generally,” “slightly” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to accompanying drawings which are provided for illustration purposes as representative of specific exemplary embodiments in which the invention may be practiced. Given the following description of the specification and drawings, the apparatus and methods should become evident to a person of ordinary skill in the art. Further areas of applicability of the present teachings will become apparent from the description provided herein. It is to be understood that other embodiments can be utilized and that structural changes based on presently known structural and/or functional equivalents can be made without departing from the scope of the invention.

### BRIEF DESCRIPTION OF THE DRAWINGS

FIG. 1A shows a side elevation view of adjustable pliers according to the present invention.

FIG. 1B shows a detailed perspective view of the adjustable pliers of FIG. 1.

FIG. 2 shows an elongated slot in an arm of the adjustable pliers of FIG. 1.

FIG. 3 shows a longitudinal cross-section through a pivot member of the adjustable pliers of FIG. 1.

FIG. 4 shows a cross-section through the pivot member shown in FIG. 3.

FIG. 5 shows the pivot member in a locked orientation in upper closed end notches of the slot with first arm indicated in ghost lines according to the present invention.

FIG. 6 shows the pivot member in an open orientation in the upper closed end notches of the slot according to the present invention.

FIG. 7 shows the pivot member in a changing orientation in the slot according to the present invention.

FIG. 8 shows the pivot member in a locked orientation in a next adjacent pair of notches in the slot according to the present invention.

FIG. 9 the pivot member in a changing orientation in the slot according to the present invention.

FIG. 10 shows the pivot member in an open orientation in the upper closed end notches of the slot according to the present invention.

FIG. 11 shows the pivot member in a locked orientation in the upper closed end notches of the slot according to the present invention.

Similar reference characters denote corresponding features consistently throughout the attached drawings.

### DETAILED DESCRIPTION OF THE DRAWINGS

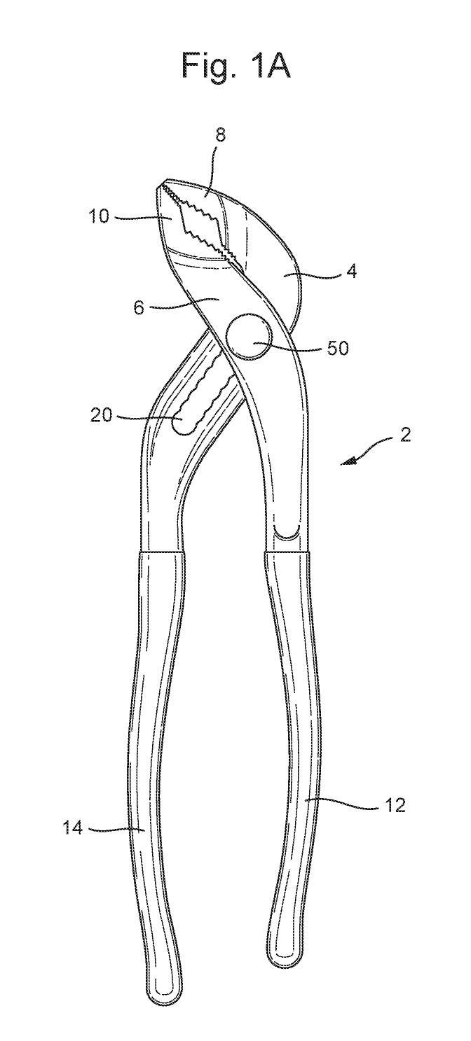

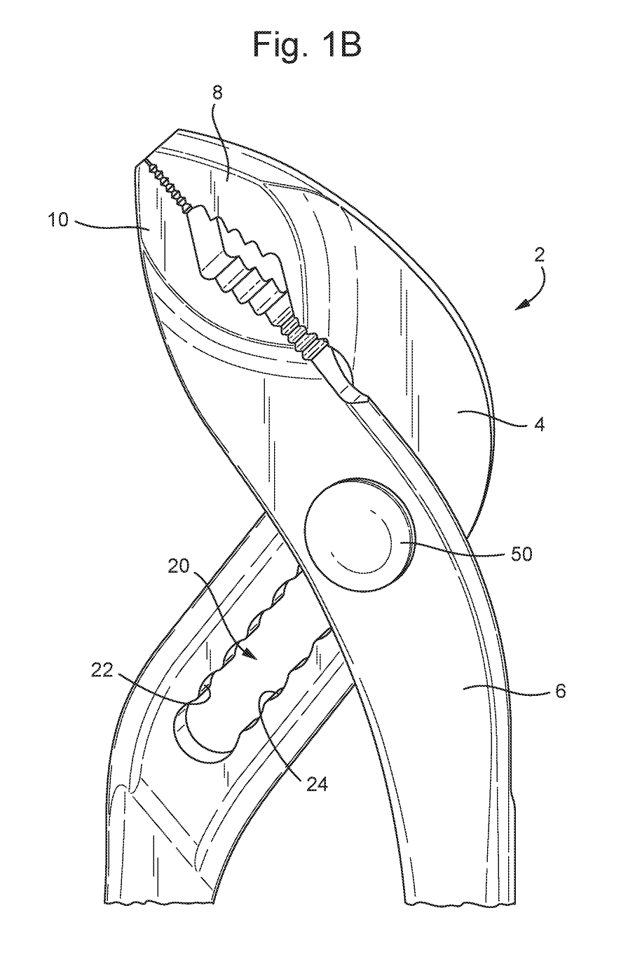

With reference now to the drawings, in particular to FIGS. 1-11, thereof, apparatuses embodying features, principles, and concepts of various exemplary embodiments of an adjustable plier will be described.

Referring to FIGS. 1A to 5, the adjustable pliers 2 comprises two elongated arms 4, 6 each terminated with a respective jaw 8, 10 at one end and each terminated with a respective handle 12, 14 at the other opposite end to the jaws 8, 10.

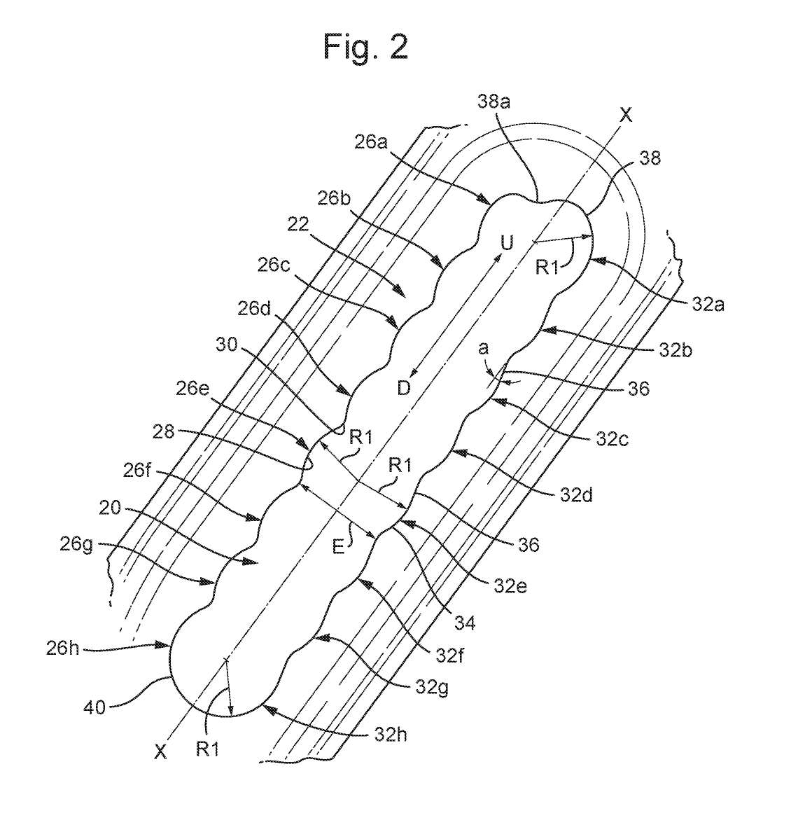

FIG. 1 illustrates a first arm 4 comprises an elongated slot 20 having an axis of elongation X-X. The slot 20 is located intermediate the arm 4 and it passes through the arm 4. The second arm 6 is keyed or operately connected to a pivot pin 50 having a central axis of rotation Y-Y. The pin 50 passes through the slot 20 and is slidable along the axis X-X of the slot 20 in an up direction U and in a down direction D, as is indicated by the double-headed arrow in FIG. 2.

An upper major side 22 and a lower major side 24 of the slot 20 each have a series of eight notches in which the pivot pin 20 can be immobilized to determine the adjustment position of the jaw 10 in relation to the jaw 8. The upper major side 22 is so-called because it is closer to the jaws 8, 10 than the lower major side 24.

A plurality or series of eight upper notches 26a-26h in the upper major side 22 of the slot 20 are each defined (using upper notch 26e as an example in FIG. 2) by a respective concave circular upper arc 28 having a first radius R1 measured from the axis X-X. The first radius R1 is approximately 3.5 mm to 4 mm although this may vary depending on the size of the adjustable pliers 2. Preferably, the first radius R1 is 3.75 mm but is not limited in this regard and can be any size. The series of upper arcs 28 are united by convex upper curves 30 which form teeth protruding towards the axis X-X of the slot 20. The teeth 30 have a radius much smaller than the first radius R1.

The series of eight lower notches 32a-32h on the lower major side 24 of the slot 20 are each formed (using lower notch 32e as an example in FIG. 2) by a respective concave circular lower arc 34 also having the first radius R1 measured from the axis X-X. The series of lower arcs 34 are united together by straight line portions 36 which form teeth protruding towards the axis X-X of the slot 20. The straight line portions 36 slope away from the axis X-X (in the down direction D) by an angle α. The angle α is approximately 15 degrees with respect to a line parallel to the axis X-X. The transitions between straight line portions 36 and adjacent lower arcs 34 are slightly rounded to avoid sharp edges.

The upper 26a and lower 32a notches join at the upper extreme end of the slot 20 to form a closed end 38 comprising a circular portion and a protrusion 38a which protrudes from between the axis X-X and the upper major side 22 towards the interior of the slot. The upper 26h and lower 32h notches join at the lower extreme end of the slot 20 to form a closed end 40 comprising a circular portion.

The eight upper notches 26a-26h and the eight lower notches 32a-32h collectively form eight circular apertures 26a-26h, 32a-32h joined by the elongated slot 20.

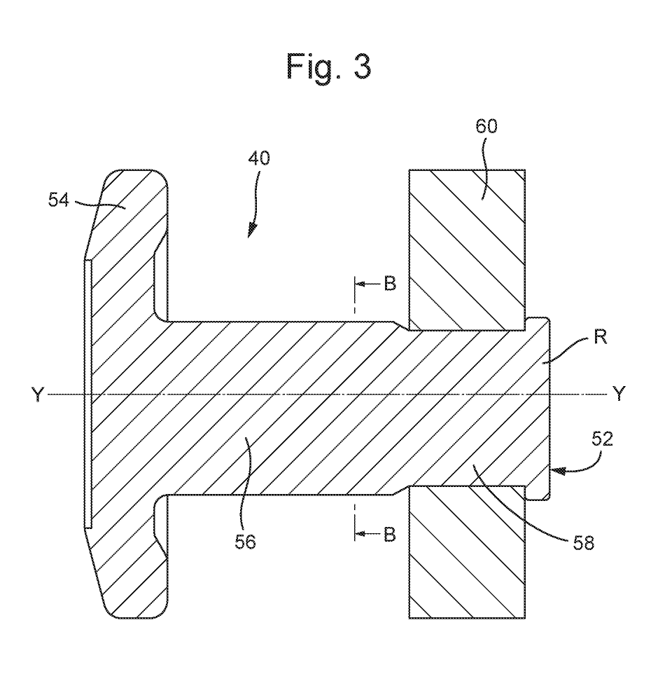

Referring in particular to FIG. 3, the pivot pin 50 comprises a shaft 52 with a generally circular head 54 at one end and integral with the shaft 52. The shaft 52 comprises a profiled section 56 adjacent the head 52 and a cylindrical portion 58 at the other end of the pin 50 from the head 54. The profiled section 56 has a non-cylindrical cross-sectional shape, as is described in more detail below. A generally circular head 60 is riveted to the shaft's cylindrical portion 56. The radius of the two heads 54, 60, measured from the central axis Y-Y of the pivot pin 50, is at least twice the size of first radius R1. When the adjustable pliers 2 are assembled, the arms 4, 6 are held between the two heads 54, 60.

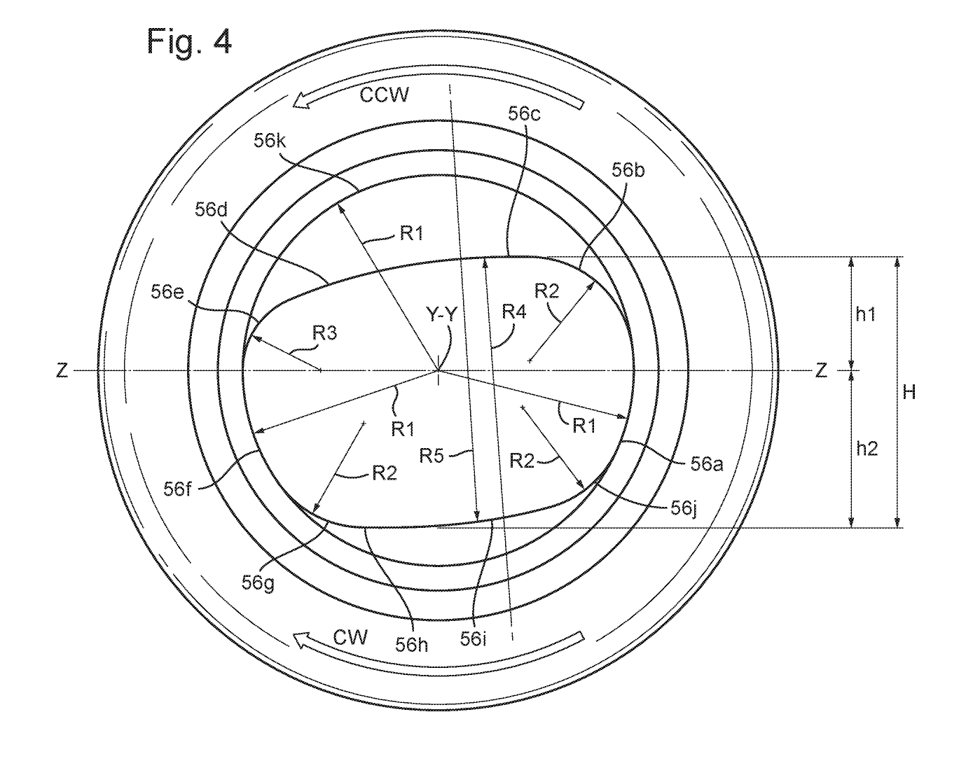

Referring in particular to FIG. 4, the profiled section 56 comprises a ring or plurality of convex curved and flat faces 56a to 56i arranged about the axis Y-Y. Starting on the right side of the profiled section 56 (as it is shown in FIG. 4), and continuing in a counter-clockwise direction CCW around the axis Y-Y, the profiled section 56 comprises a convex curved right locking face 56a, a convex curved top right free face 56b, a top flat free face 56c, a convex curved top free face 56d, a convex curved top left free face 56e, a convex curved left locking face 56f, a convex curved bottom left free face 56g, a bottom flat free face 56h, a convex curved bottom free face 56i and a convex curved bottom right free face 56j.

The plurality of convex curved faces 56a, 56b, 56d, 56e, 56f, 56g, 56h, 56i, 56j that are curved in cross-section, as is shown in FIG. 4, are convex curvilinear faces arranged parallel to the axis Y-Y, as is shown in FIG. 3. Likewise, the flat free faces 56a, 56i that are flat in cross-section, as is shown in FIG. 4, are planar faces arranged parallel to the axis Y-Y, as is shown in FIG. 3.

The right locking face 56a and the left locking face 56f are the outermost faces of the profiled section 56, measured from the axis Y-Y, and lie on parts of a notional outer circular perimeter 56k of the profiled section 56. Each of the right locking face 56a and the left locking face 56f has the same first radius R1 measured from the axis Y-Y as the first radius R1 of the eight circular apertures 26a-26h, 32a-32h joined by the slot 20.

The right locking face 56a, the top right free face 56b and the bottom right free face 56j combine to form a smooth arc of varying radii. The top right free face 56b has a second radius R2 measured from a point on the same side of an axis Z-Z as the top right free face 56b. The axis Z-Z is an axis of elongation of the profiled section 56 which is parallel to the top 56c and the bottom 56h flat free faces of the profiled section 56. The bottom right free face 56j has the same second radius R2 albeit measured from another point on the same side of the axis Z-Z as the bottom right free face 56j. The second radius R2 is approximately 1.75 mm to 2.25 mm although this may vary depending on the size of the adjustable pliers 2. Preferably, the second radius R2 is 2 mm but is not limited in this regard and can be any size.

The right locking face 56a sweeps an angle of approximately 30 degrees measured from the axis Y-Y. The top right free face 56b sweeps away from the circular perimeter 56k, in a clockwise direction CW, and recedes towards the axis Y-Y until it meets the top flat free face 56c. The bottom right free face 56j sweeps away from the circular perimeter 56k, in a counter-clockwise direction CCW, and recedes towards the axis Y-Y until it meets the bottom free face 56i.

The left locking face 56f, the top left free face 56e and the bottom left free face 56g combine to form a smooth arc of varying radii. The bottom left free face 56g has the same second radius R2 albeit measured from another point on the same side of the axis Z-Z as the bottom left free face 56g. The top left free face 56e has a third radius R3 measured from a point on the axis Z-Z. The radius R3 is approximately 1.25 mm to 1.75 mm although this may vary depending on the size of the adjustable pliers 2. Preferably, the third radius R3 is 1.5 mm but is not limited in this regard and can be any size.

The left locking face 56f sweeps an angle of approximately 30 degrees measured from the axis Y-Y. The top left free face 56e sweeps away from the circular perimeter 56k, in the clockwise direction CW, and recedes towards the axis Y-Y until it meets the top free face 56d. The bottom left free face 56g sweeps away from the circular perimeter 56k, in the counter clockwise direction CCW, and recedes towards the axis Y-Y until it meets the bottom flat free face 56h.

The top 56c and the bottom 56h flat free faces are parallel to the axis of elongation Z-Z through the profiled section 56. The axis Z-Z crosses the axis Y-Y and is orthogonal thereto. A distance H between the top 56c and the bottom 56h flat free faces, in a direction orthogonal to the axes Y-Y and Z-Z, is divided into a distance h1 (between the top planar free face 56c and axis Z-Z) and a distance h2 (between the bottom planar free face 56h and axis Z-Z). The distance h1 is approximately 2.1 to 2.3 mm although this may vary depending on the size of the adjustable pliers 2. Preferably, the distance h1 is 2.2 mm but is not limited in this regard and can be any size. The distance h2 is approximately 2.9 to 3.1 mm although this may vary depending on the size of the adjustable pliers 2. Preferably, the distance h2 is 3 mm but is not limited in this regard and can be any size. The profiled section 56 is contained within the distance H between the top 56c and the bottom 56h flat free faces. The top 56c and the bottom 56h flat free faces are both less than 0.5 mm long but they cause some elongation of the profiled section 56 is a direction of the axis elongation Z-Z. Distance H is less than distance E between opposing convex curves 30 and straight line portions 36 in the slot 20.

The top free face 56d has a fourth radius R4 of approximately 10 mm measured from a point on the opposite side of the axis Z-Z to the top free face 56d. The top free face 56d forms an arc between the top flat free face 56c and the top left free face 56e. The top flat free face 56c joins both the top right free face 56b and the top free face 56d at a tangent to avoid any corners.

The bottom free face 56i has a fifth radius R5 of approximately 14 mm measured from a point on the opposite side of the axis Z-Z to the bottom free face 56i. The bottom free face 56i forms an arc between the bottom flat free face 56h and the bottom right free face 56j. The bottom flat free face 56h joins both the bottom left free face 56g and the bottom free face 56i at a tangent to avoid any corners.

The axis Z-Z bisects the right locking face 56a. The axis Z-Z passes through the transition between the left locking face 56f and the top left free face 56e.

The profiled section 56 has a generally convex curved shape in cross-section albeit including two relatively small flat faces 56c, 56h. The increased size of the fourth radius R4 and the fifth radius R5 and the inclusion of the top 56c and bottom 56h flat faces elongate the profiled section 56 in the direction of the axis Z-Z. The reduced third radius R3 of the top left free face 56e narrows the left side of the profiled section 56 (measured in a direction orthogonal to the axis Z-Z). This gives profiled section 56 a slightly curved trapezoidal shape with a narrower end that includes the left locking face 56f.

The right 56a and left 56f locking faces are so-called because they are used to lock, or fix, the pivot pin 50 against sides of the pairs of opposing upper 26 and lower 32 notches along the length of the slot 20. The top right 56b, top flat 56c, top 56d, top left 56e, bottom left 56g, bottom flat 56h, bottom 56i and bottom right 56j free faces are so-called because they are shaped to move freely in the slot 20 without necessarily contacting the convex curves 30 of the upper notches 26 or the straight line portions 36 of the lower notches 32.

On one side of the axis Z-Z, the top right 56b, top flat 56c, top 56d and top left 56e free faces may be collectively referred to as one free face. On the other side of the axis Z-Z, the bottom left 56g, bottom flat 56h, bottom 56i and bottom right 56j free faces may be collectively referred to as the other free face.

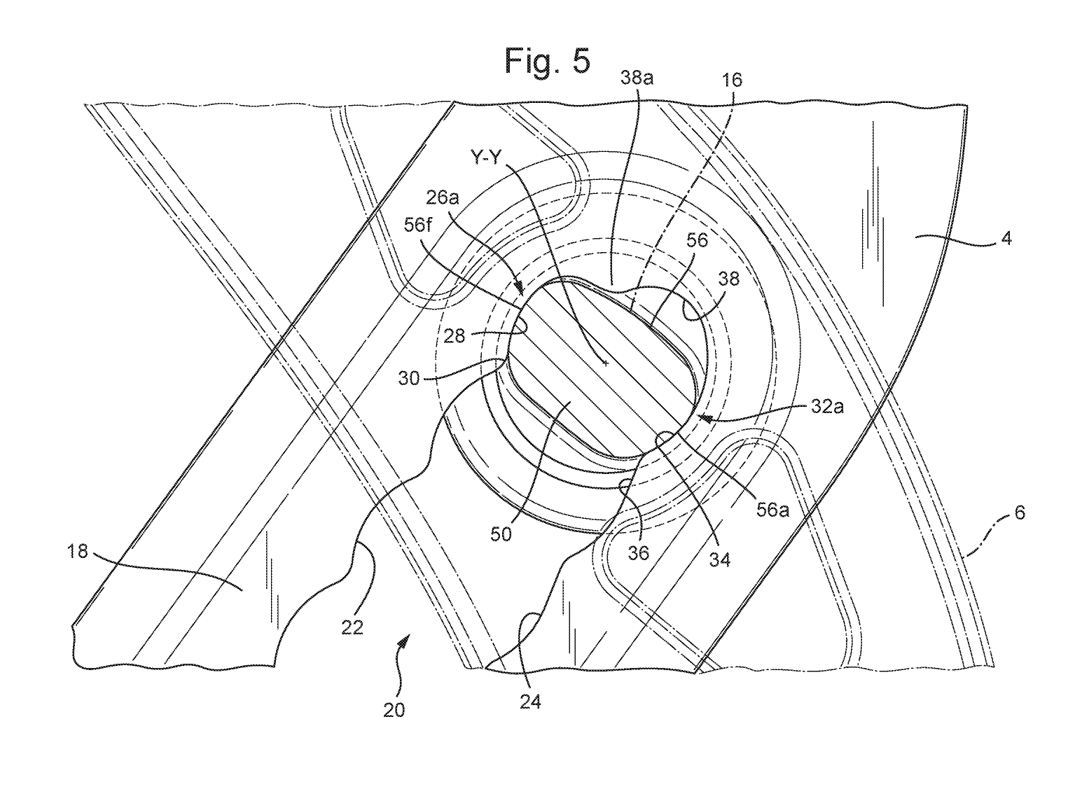

Referring to FIGS. 3 and 5, the arm 6 has a pivot pin hole 16 through a side facing the slot 20 in the arm 4. The pivot pin hole 16 is corresponds in shape to the non-circular cross-sectional shape of the profiled section 56. During assembly of the adjustable pliers 2, the pivot pin 50 is inserted through the elongated slot 20 until the head 54 abuts the arm 4. Then, the pivot pin 50 is inserted through the pivot pin hole 16 until the arm 6 abuts a raised shoulder 18 on the arm 4 surrounding the elongated slot 20. The arm 6 is now keyed to profiled section 56 of the pivot pin 50 in a way that the arm 6 and the pivot pin 50 move in unison. Finally, the head 60 is riveted to the cylindrical section 58 of the shaft 52 to permanently hold the arms 4, 6 between the heads 54, 60. A bulge R at the end of the cylindrical section 58 indicates where the head 60 is riveted to of the shaft 52. The arm 4 may slide along the raised shoulder 18 on the arm 6 while the profiled section 56 slides inside the slot 20 in order to adjust the opening of the jaws 8, 10, as is described in more detail below. The pivot pin 50 and the head 60 form a so-called pivot member which acts as an axis of articulation of the adjustable pliers 2.

Referring to FIG. 5, the arm 6 is shown in a position in relation to the arm 4 where the pivot pin 50 is through the upper closed end 38 of the elongated slot 20. In this position, the jaws 8, 10 have been adjusted to the closest possible opening position. To close the jaws 8, 10, and grip an object, an operator squeezes the adjustable pliers' handles 12, 14 together in a way that rotates the pivot pin 50 a small amount in a clockwise direction CW to the locked orientation shown in FIG. 5. The right locking face 56a abuts the side of the lower arc 34 of the lower notch 32a of the upper closed end 38. The left locking face 56f abuts the side of the upper arc 28 of the upper notch 26a of the upper closed end 38. The pivot pin 50 is prevented from moving out of the upper closed end 38 in the down direction D. Play between the upper closed end 38 and the pivot pin 50 is reduced, or eliminated, by the protrusion 38a which prevents the pivot pin 50 from moving in the up direction U.

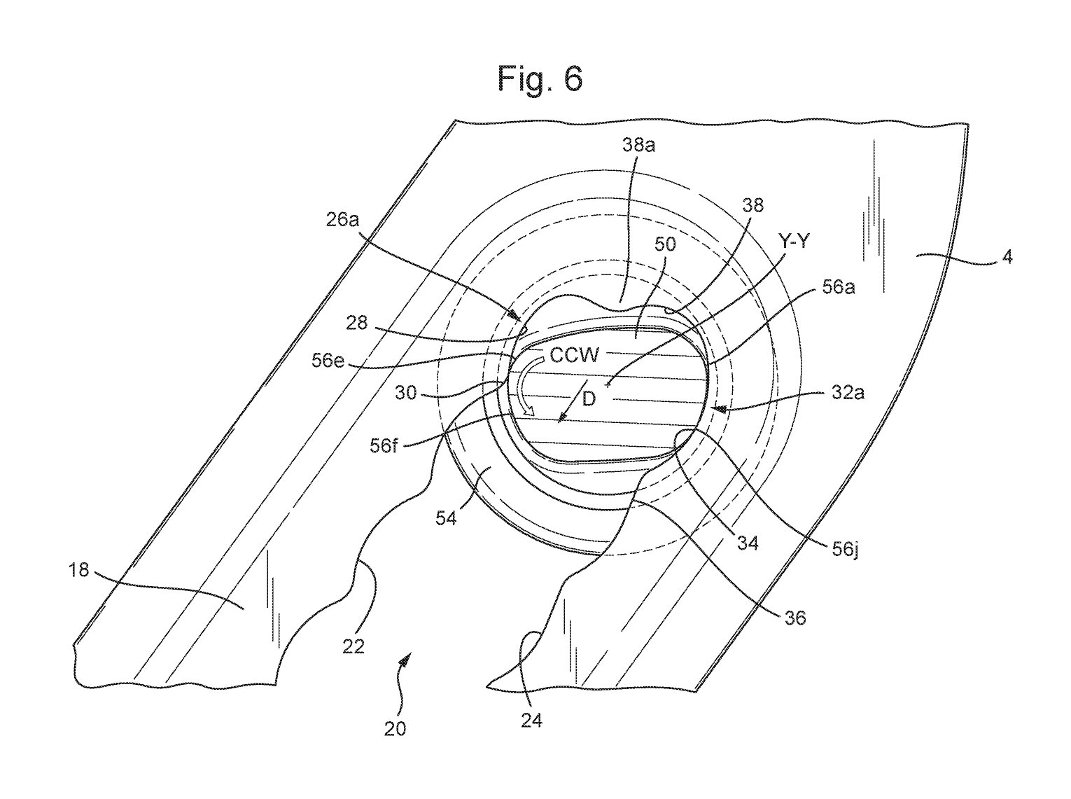

Referring to FIG. 6, the squeeze on the adjustable pliers' handles 12, 14 has been released and the arm 6 is rotated in relation to the arm 4 a small distance to open the jaws 8, 10. Accordingly, the pivot pin 50 is rotated a small amount in the counter-clockwise direction CCW to an open orientation. The pivot pin 50 remains largely in the upper closed end 38 of the elongated slot 20, as is shown in FIG. 6. The right locking face 56a disengages the lower notch 32a. Now, the bottom right free face 56j is adjacent the lower arc 34 of the lower notch 32a of the upper closed end 38. Since the second radius R2 is less than the first radius R1, the axis Y-Y of the pivot pin 50 may slightly approach the lower notch 32a. The left locking face 56f may disengage the upper arc 28 and pass under the convex curve 30 of the upper notch 26a of the upper closed end 38. Since the third radius R3 is less than second radius R2, and a lot less than first radius R1, the top left free face 56e clears the convex curve 30 of the upper notch 26a of the upper closed end 38 too. The pivot pin 50 is ready to leave the upper 26a and lower 32a notches of the upper closed end 38 of the elongated slot 20.

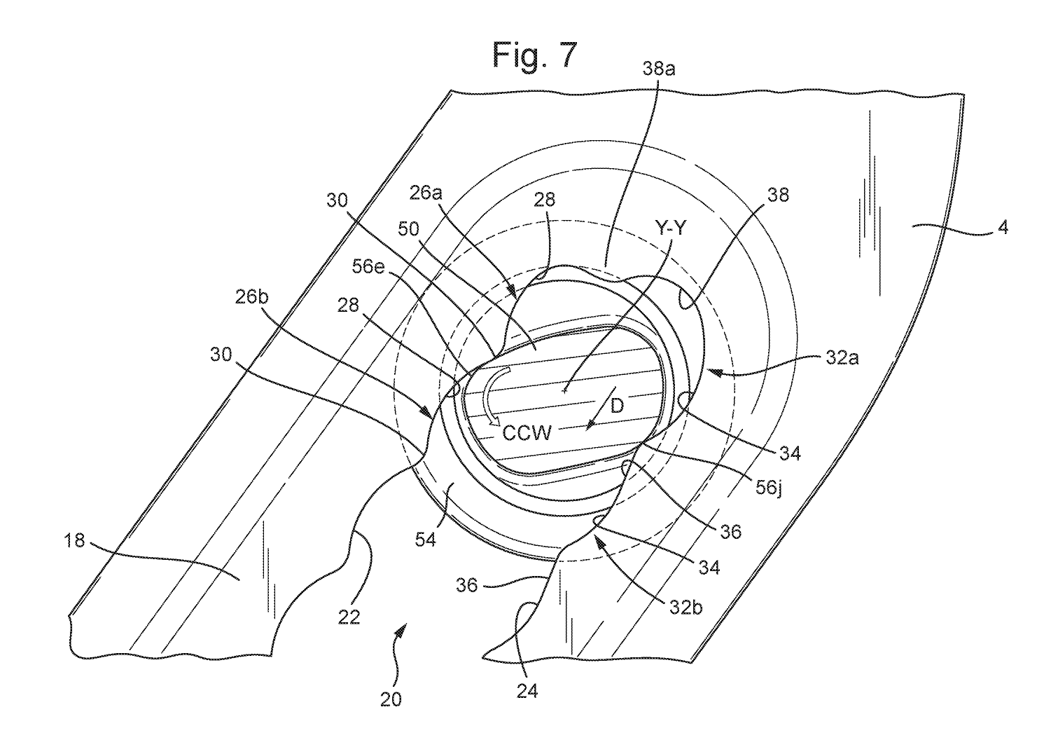

Referring to FIG. 7, the squeeze on the adjustable pliers' handles 12, 14 has been further released and the arm 6 is further rotated in relation to the arm 4 to further open the jaws 8, 10. Accordingly, the pivot pin 50 is further rotated in the counter-clockwise direction CCW to a changing orientation. Also, the pivot pin 50 is moved a small distance in the down direction D to leave the upper closed end 38 of the slot 20, as is shown in FIG. 7. There may be smooth sliding contact between the bottom right free face 56j and the lower arc 34 of the lower notch 32a which may help guide the pivot pin 50 out of the upper closed end 38 towards the next adjacent pair of opposing notches (in the down direction D from the upper closed end 38).

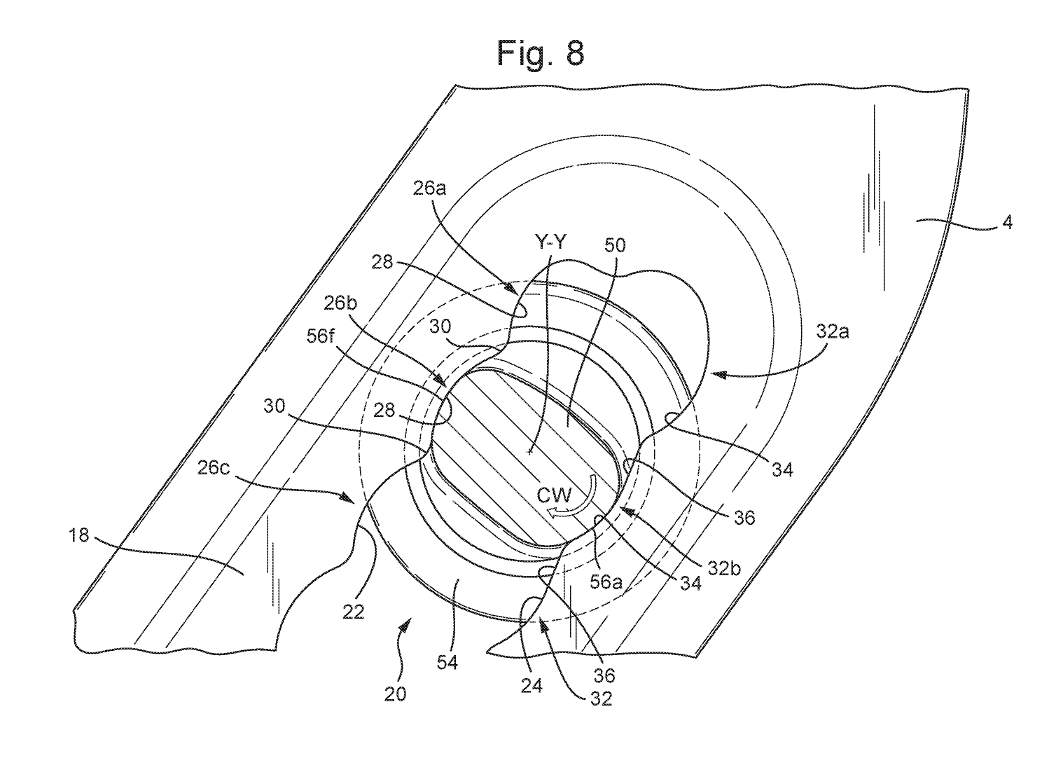

Referring to FIG. 8, the pivot pin 50 has arrived in the next adjacent pair of opposing notches which, in the present example, is the upper 26b and lower 32b notches. In this position, the jaws 8, 10 have been adjusted to their second closest opening position. To close the jaws 8, 10, and grip an object, an operator squeezes the adjustable pliers' handles 12, 14 together in a way that rotates the pivot pin 50 a small amount in a clockwise direction CW to another locked orientation, as is shown in FIG. 8. Forces generated by the jaws 8, 10 gripping an object act in a way that forces the pivot pin 50 in the down direction D. The right locking face 56a abuts the side of the lower arc 34 of the lower notch 32b. The left locking face 56f abuts the side of the upper arc 28 of the upper notch 26b. Support provided by sides of the upper 28 and lower 34 arcs reacts against these forces and prevents the pivot pin 50 from moving in the down direction D and into the next adjacent pair of opposing upper 26c and lower 32c notches.

The process of adjusting the position of the arms 4, 6 in relation to each other, as described above with reference to FIGS. 5 to 8, widens the opening of the jaws 8, 10. Any one of eight positions along the slot 20 may be selected according to which pair of notches, or the plurality of apertures, 26a-26h, 32a-32h is occupied by the pivot pin 50. Selection of the aperture 26a, 32a at the upper closed end 38 narrows the opening between the jaws 8, 10. Selection of the aperture 26h, 32h at the lower closed end 40 widens the opening between the jaws 8, 10. Adjustment need not be done incrementally along the elongated slot 20. When in the changing orientation, as is shown in FIG. 7, the pivot pin 50 may slide from the upper closed end 38 to the lower closed end 40 and, in doing so, it may select any one of eight apertures 26a-26h, 32a-32h along the slot 20.

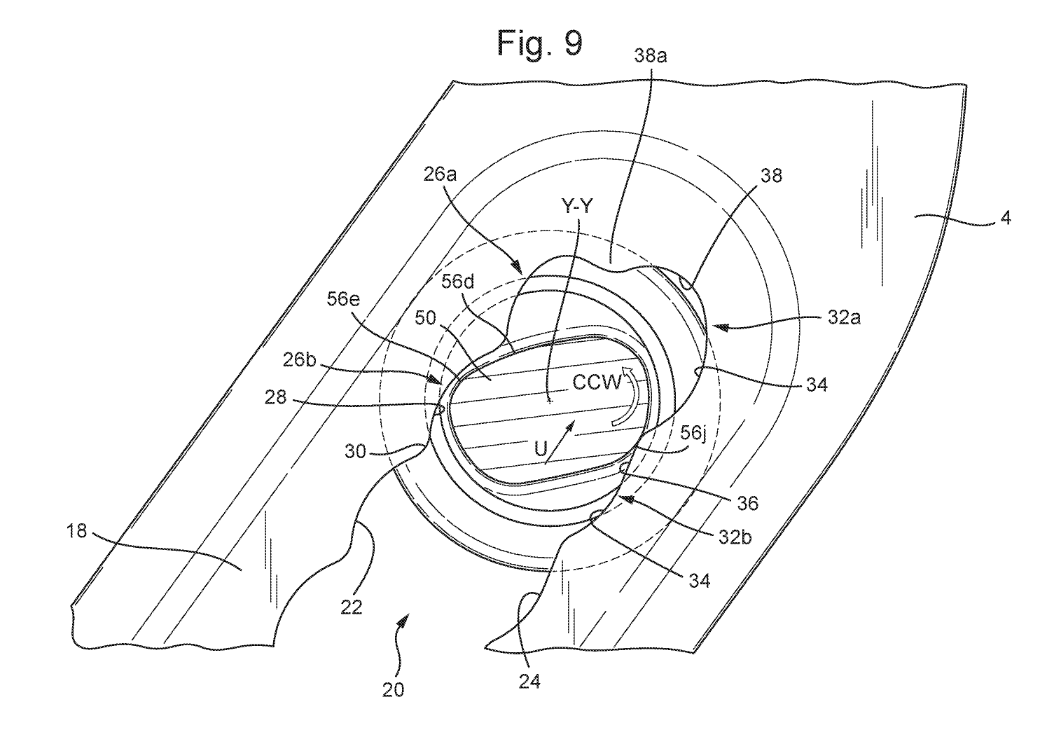

The process of adjusting the position of the arms 4, 6 in relation to each other to narrow the opening between the jaws 8, 10 is described with reference to FIGS. 9 to 11.

Referring to FIG. 9, the squeeze on the adjustable pliers' handles 12, 14 has been released and the arm 6 is rotated in relation to the arm 4 to open the jaws 8, 10. Accordingly, the pivot pin 50 is rotated in the clockwise direction CW into an open orientation, as is shown in FIG. 9. Also, the pivot pin 50 is moved a small distance in the up direction U to leave the upper 26b and the lower 32b notches of the slot 20. The bottom right free face 56j may slide smoothly along the straight line portion 36 of the lower notch 32b (in the up direction U). The left locking face 56f disengages the upper arc 28 of the upper notch 26b. The top free face 56d is clear of the convex curve 30 of the upper notch 26b.

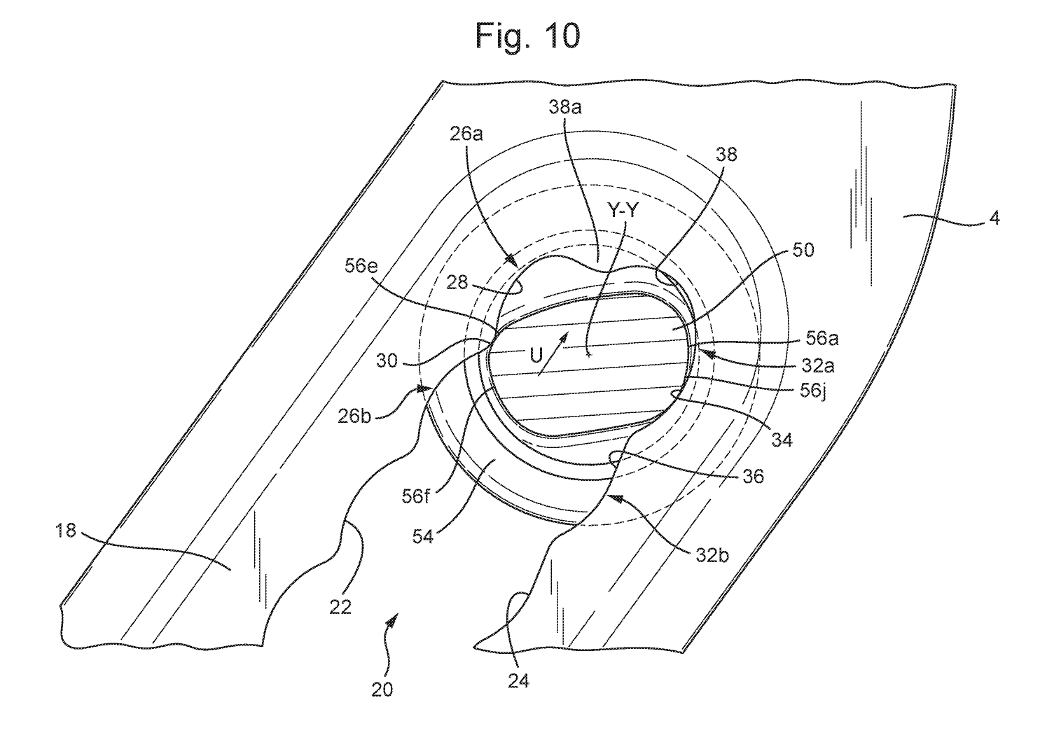

Referring to FIG. 10, the pivot pin 50 is in the changing orientation. The operator moves the adjustable pliers' handles 12, 14 in relation to each other in a way that moves the pivot pin 50 a small amount in the up direction U along the elongated slot 20. The right locking face 56a abuts the side of the lower arc 34 of the lower notch 32a. Since the second radius R2 is less than the first radius R1, the axis Y-Y of the pivot pin 50 may approach the lower notch 32a. The left locking face 56f may disengage the side of the upper arc 28 of the upper notch 26b and pass under the convex curve 30 of the upper notch 26a of the upper closed end 38. Since the third radius R3 is less than the second radius R2, and a lot less than first radius R1, the top left free face 56e passes under the convex curve 30 of the upper notch 26a of the upper closed end 38 too. Now, the pivot pin 50 is partially in the upper 26a and lower 32a notches of the upper closed end 38 of the slot 20.

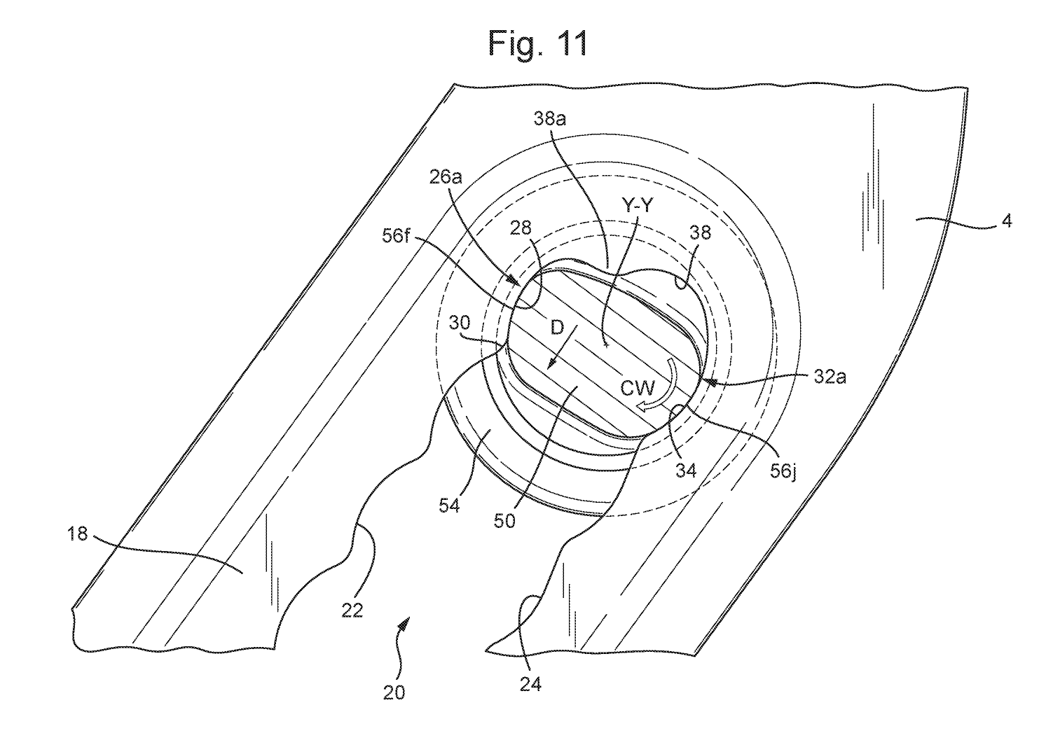

Referring to FIG. 11, the pivot pin 50 has moved into the upper closed end 38 of the elongated slot 20. In this position, the jaws 8, 10 have been adjusted back into their closest opening position. To close the jaws 8, 10, and grip an object, an operator squeezes the adjustable pliers' handles together in a way that rotates the pivot pin 50 a small amount in a clockwise direction CW to a locked orientation, as is shown in FIG. 11. Forces generated by the jaws 8, 10 gripping an object act in a way that forces the pivot pin 50 in the down direction D. The right locking face 56a abuts the side of the lower arc 34 of the lower notch 32a. The left locking face 56f abuts the side of the upper arc 28 of the upper notch 26a. Support provided by the upper arc 28 and the lower arc 34 reacts against these forces and prevents the pivot pin 50 from moving in the down direction D and into the next adjacent pair of opposing upper 26b and lower 32b notches.

Respective features of the illustrated embodiments may be combined in a different combinations as required by particular circumstances or preferences so as to provide the functionality of an adjustable plier.

It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying drawings illustrate exemplary embodiments of the invention.

It should be understood, therefore, that the invention is not limited to the specific embodiments disclosed herein, and that modifications and other embodiments of the invention are intended to be included within the scope of the invention. Those skilled in the art should now appreciate that various adaptations and modifications of the example and alternative embodiments described above can be configured without departing from the scope and spirit of the invention. Therefore, it is to be understood that, within the scope of the appended claims, the invention may be practiced other than as specifically described herein.

We claim:

1. An adjustable plier comprising:
a first arm and a second arm crossing each other intermediate of their ends, wherein each arm has a respective clamping jaw at one end and a respective handle at an opposite end thereof,
wherein the first arm has intermediate of its ends and at the crossing by the second arm a plurality of spaced apart apertures through the first arm the apertures being connected by an elongated slot through the first arm, the slot being of lesser width than the apertures,
wherein the second arm has a pivot member passing through the elongated slot to pivotally connect the arms to each other,
wherein the pivot member has a profiled section receivable within any one of the apertures,
wherein the profiled section comprises opposing convex curved locking faces each with a common axis of curvature and a first radius defining a notional outer circular perimeter of the profiled section,
wherein the profiled section comprises a plurality of substantially opposing free faces separating the locking faces each free face being inset from the notional outer circular perimeter,
wherein the other arm is pivotable in respect of the one arm in a rotational direction about the axis to cause engagement of the locking faces with a side of the first arm defining one of the apertures to determine the opening of the jaws with respect to each other and the second arm is pivotable in respect of the one arm in a counter rotational direction about the axis to cause disengagement of the locking faces from sides of the apertures to allow movement of the pivot member along the slot to vary the opening of the jaws with respect to each other; and
further comprising: at least one free face including a convex curved free face flanking one locking face in the rotational direction and having a second radius that is less than the first radius of the locking faces wherein the at least one second free face comprises a convex curved free face flanking the other locking face in the rotational direction and having a third radius, wherein the third radius is less than the second radius.

2. An adjustable plier according to claim 1, wherein the profiled section has a generally curved trapezoidal shape in cross-section tapering towards the locking face flanked by the convex curved free face having the third radius.

3. An adjustable plier according to claim 1 or 2, wherein the profiled section is elongated between the opposing locking faces and has an axis of elongation which separates the plurality of free faces.

4. An adjustable plier according to claim 3, wherein a majority of the locking faces lies on an opposite side of the axis of elongation to the jaws.

5. An adjustable plier according to claim 4, wherein the convex curved free face having the third radius lies on an opposite side of the axis of elongation to the majority of the locking faces.

6. An adjustable plier according to any one of the claims 3-5, wherein the free faces are substantially convex.

7. An adjustable plier according to claim 6, wherein each face of the plurality of free faces comprises a flat free face parallel to the axis of elongation.

8. An adjustable plier according to claim 7, wherein each flat free face merges tangentially with convex curved free faces of its respective free face

9. An adjustable plier according to claim 8, wherein each free face comprises a convex curved free face flanking a respective locking face in the counter rotational direction and having the second radius.

10. An adjustable plier comprising:
a pair of arms crossing each other intermediate of their ends, wherein each arm has a respective clamping jaw at one end and a respective handle at an opposite end thereof, wherein one arm has intermediate of its ends and at the crossing by the other arm a plurality of spaced apart apertures traversing the one arm; and
the apertures being connected by an elongated slot of lesser width than the apertures, wherein the other arm has a pivot member passing through the slot to pivotally connect the arms to each other, wherein the pivot member has a profiled section receivable within any one of the apertures, and wherein the pivot member is configured to move along the slot to vary the opening of the jaws.
